(19) United States
(12) Patent Application Publication
(10) Pub. No.: US 2006/0054801 A1
(43) Pub. Date: Mar. 16, 2006

(54) Biochip scanning device

(76) Inventors: Long-Song Cheng, Hsinchu (TW); Meng-Ta Tsai, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/924,793

(22) Filed: Aug. 25, 2004

(51) Int. Cl. G01J 1/04; G01D 5/38

(52) U.S. Cl. 250/237 R

(57) ABSTRACT

The present invention discloses a biochip scanning device including a light source for emitting a light; a rotatable optical grating hologram located at one side of the light source for diffracting the light to form a diffractive light; a sampling stage that can be placed a specimen and can be irradiated with the diffractive light; and a linear charge coupled device (CCD) that can receive a reflective light of the diffractive light via the specimen. With the rotatable optical grating hologram, the light can be uniformly diffracted, and a more correct signal noise ratio is obtained to ensure accuracy of the light signal. In addition, the light can be replaced by a linear light source to effectively improve the scan speed and save the testing time.

### BACKGROUND OF INVENTION

1. Field of the Invention

The invention relates to a biochip scanning device, and more particularly, to a biochip scanning device that can get more correct signal noise ratio to ensure accuracy of the light signal.

2. Description of the Prior Art

With the rapid development of the biology technology, the detection of DNA has become essential information for human heredity, disease and identification, and especially for preventing the early stage of tumor and tracking the medicine result. Hence, accuracy of the DNA detection equipment is very important. Generally, the DNA detection equipment is a biochip scanner. When a DNA sample is smeared over the testing flake, for detecting difference between A, G, C, T nucleotides, a fluorescent stain will be formed in the testing flake in advance. When light with a suitable wavelength irradiates the sample, the different fluorescent brightness of different kinds of DNA can be used to determine whether the nucleotide exists. Because the fluorescent reaction is very weak, the signal noise ratio (SNR) of the detection signal of the fluorescent brightness reaction is become very important.

Please refer to FIG. 1, which is a schematic diagram of a front-projecting reflective type biochip scanning device according to the prior art. As shown in FIG. 1, the biochip scanning device 1 includes a laser emitter 11 for emitting laser; a excitation spectral filter 12 for filtering the wavelength accuracy of the excited light required by the fluorescent stain; a light splitter 13 whose one side can transmit light and the other side can reflect light; a focusing object lens 14 for focusing light transmitting the light splitter 13; a sampling stage 15 for placing a specimen 151, the sampling stage 15 can be freely moved along the X-Y directions, and the light focused by the focusing object lens 14 can be used to scan with single point on the specimen 151; a fluorescent emission spectral filter 16 for filtering the excited fluorescent signal of the specimen 151 after being scanned; a sensor imaging lens 17 for focusing the fluorescent signal passing the fluorescent emission spectral filter 16; and a signal detecting receiver 18 for receiving the fluorescent signal focused by the sensor imaging lens 17. When performing the scanning procedure, the sampling stage 15 is moved rapidly along the X-Y directions, and all specimens 151 can be scanned and analyzed with single point. However, the back and forth movement of the sampling stage 15 will waste time and make the system vibrating.

Please refer to FIG. 2, which is a schematic diagram of a back-projecting transmissive type biochip scanning device according to the prior art. As shown in FIG. 2, the structure of the biochip scanning device 2 is similar to that of the biochip scanning device 1, but only the light splitter 13 is removed. The function and principle of the single point scanning are the same, and also have the problem of time waste and system vibration.

Please refer to FIG. 3, which is a schematic diagram of another front-projecting reflective type biochip scanning device according to the prior art. As shown in FIG. 3, the structure of the biochip scanning device 3 is similar to that of the biochip scanning device 1, but a rotatable reflective mirror 31 is located between the reflective sheet 13 and the focusing object lens 14 to rotate in the X direction and change the reflective angle of the light. When performing the scanning procedure, the reflective mirror 31 can be rotated to change the reflective angle of the light and make the light sampling along the X direction of the sampling stage 15. The X direction movement can be omitted and the system vibration can be reduced.

Please refer to FIG. 4, which is a schematic diagram of a further front-projecting reflective type biochip scanning device according to the prior art. As shown in FIG. 4, the structure of the biochip scanning device 4 is similar to that of the biochip scanning device 3, but the rotatable reflective mirror 31 is replaced by a rotatable reflective multidimensional mirror 41. The function and principle are also similar to that of the biochip scanning device 3 that can effectively reduce the system vibration.

Please refer to FIG. 5, which is a schematic diagram of another back-projecting transmissive type biochip scanning device according to the prior art. As shown in FIG. 5, the structure of the biochip scanning device 5 is similar to that of the biochip scanning device 4, but the structure is a back-projecting transmissive type. The signal detecting receiver 18 can be also a linear charge coupled device (CCD).

Although the rotatable reflective mirror 31 or the rotatable reflective multidimensional mirror 41 in FIGS. 3, 4 and 5 can omit the X direction movement and reduce the system vibration, the mirror swing or rotation will also make the rotation axis shift and let the light source cannot focus on the specimen. In addition, with different rotation angles, the light will change shape to ellipse at edge of the specimen and make the illumination not enough and uneven, and the signal will have mistake.

For overcoming the disadvantages of the conventional biochip, the applicant now discloses a biochip scanning device to get more correct signal noise ratio to ensure accuracy of the light signal.

### SUMMARY OF INVENTION

It is therefore a primary objective of the claimed invention to provide a biochip scanning device that can get more correct signal noise ratio to ensure accuracy of the light signal.

It is therefore another objective of the claimed invention to provide a biochip scanning device that can effectively improve the scan speed.

It is therefore a further objective of the claimed invention to provide a biochip scanning device that can effectively save the testing time.

According to the claimed invention, a biochip scanning device includes a light source for emitting a light; a rotatable optical grating hologram located at one side of the light source for diffracting the light to form a diffractive light; a sampling stage that can be placed a specimen and can be irradiated with the diffractive light; and a linear charge coupled device (CCD) that can receive a reflective light of the diffractive light via the specimen. With the rotatable optical grating hologram, the light can be uniformly diffracted, and a more correct signal noise ratio is obtained to ensure accuracy of the light signal. In addition, the light can be replaced by a linear light source to effectively improve the scan speed and save the testing time.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a front-projecting reflective type biochip scanning device according to the prior art.

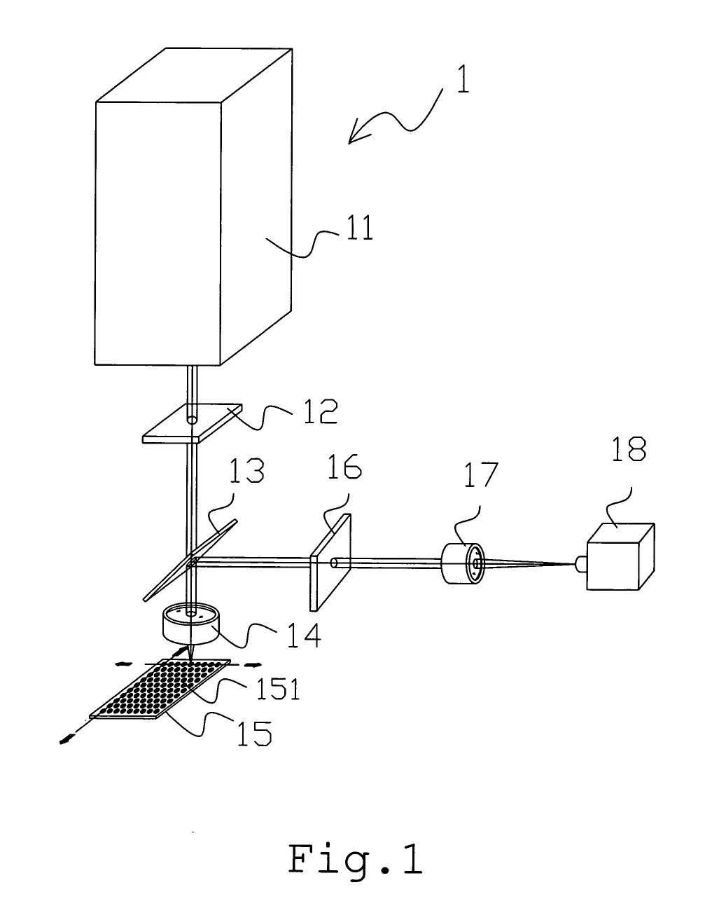

FIG. 2 is a schematic diagram of a back-projecting transmissive type biochip scanning device according to the prior art.

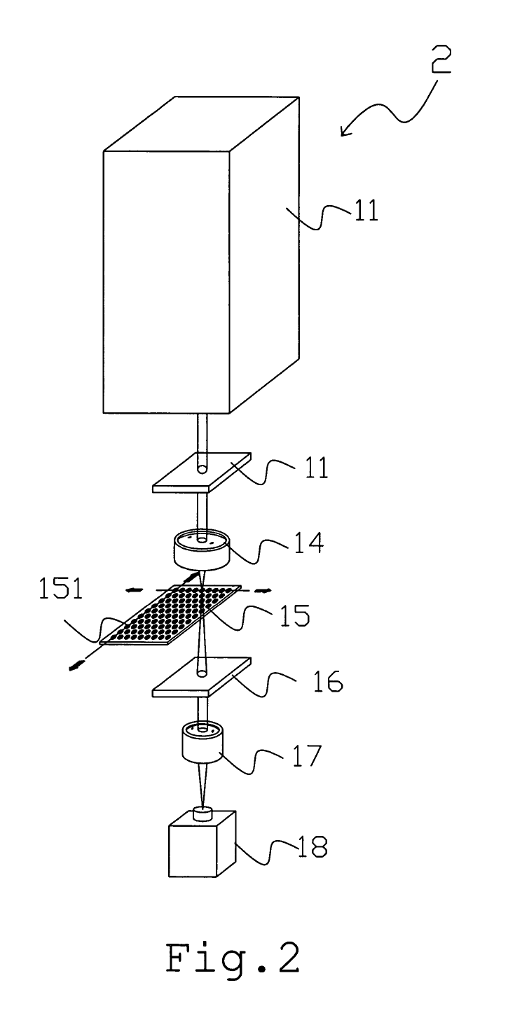

FIG. 3 is a schematic diagram of another front-projecting reflective type biochip scanning device according to the prior art.

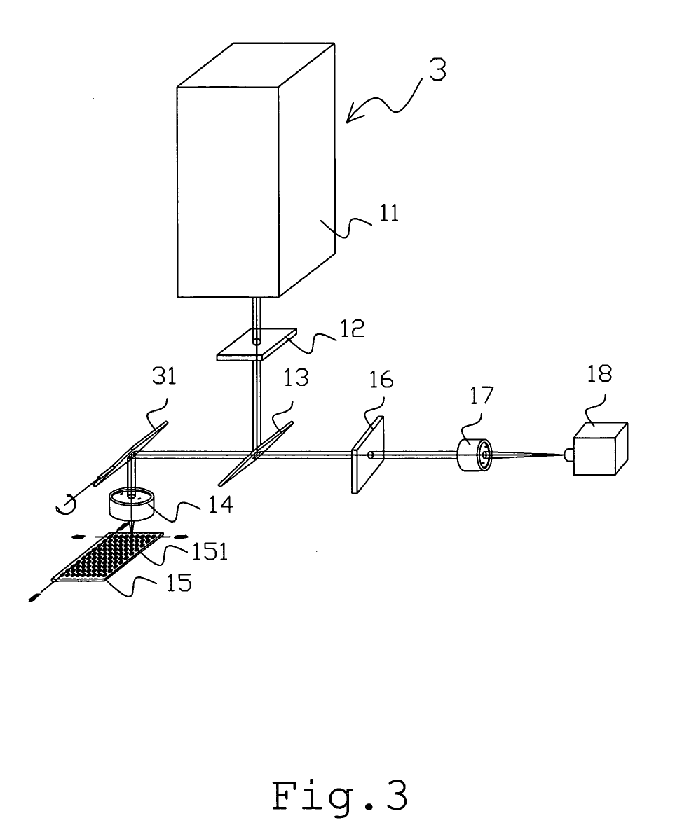

FIG. 4 is a schematic diagram of a further front-projecting reflective type biochip scanning device according to the prior art.

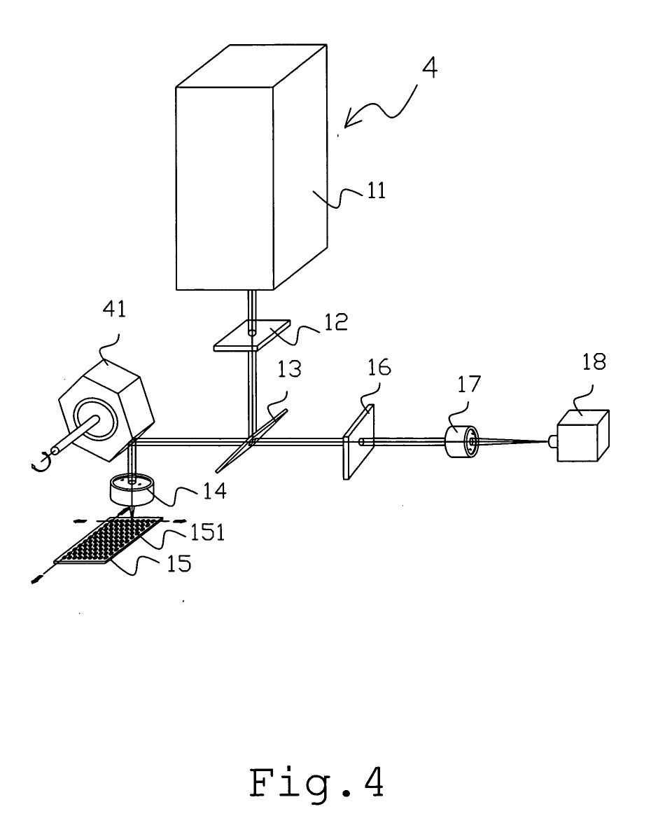

FIG. 5 is a schematic diagram of another back-projecting transmissive type biochip scanning device according to the prior art.

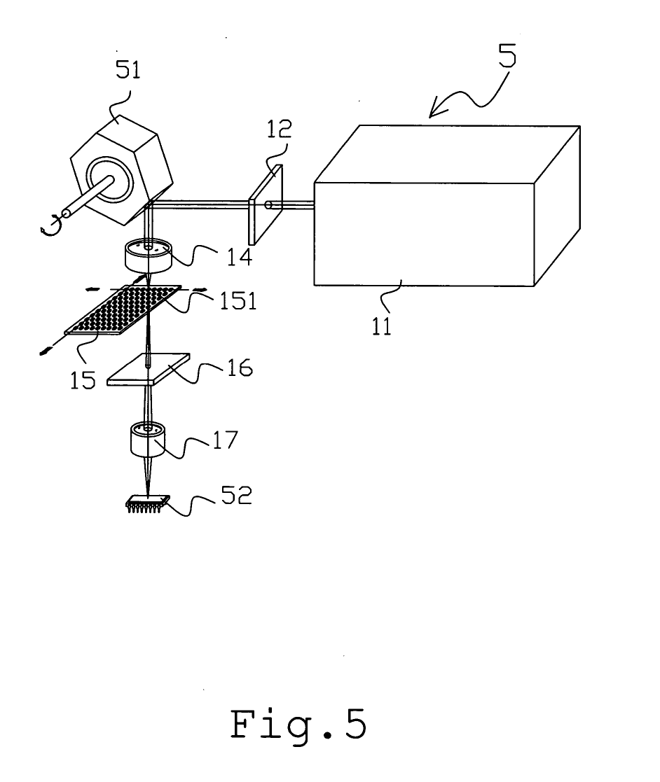

FIG. 6 is a schematic diagram of an embodiment of the present invention.

FIG. 7 is a schematic diagram of another embodiment of the present invention.

FIG. 8 is a comparison diagram of the shift of the mirror and the hologram.

FIG. 9 is a schematic diagram of a further embodiment of the present invention.

FIG. 10 is schematic diagram of a further embodiment of the present invention.

1 front-projecting reflective type biochip scanning device
11 light source
12 excitation spectral filter
13 light splitter
14 focusing object lens
15 sampling stage
151 specimen
16 fluorescent emission spectral filter
17 sensor imaging lens
18 signal detecting receiver
2 back-projecting transmissive type biochip scanning device
3 front-projecting reflective type biochip scanning device
31 rotatable reflective mirror
4 front-projecting reflective type biochip scanning device
41 rotatable reflective multidimensional mirror
5 back-projecting transmissive type biochip scanning device
51 rotatable reflective multidimensional mirror
52 linear charge coupled device
6 front-projecting reflective type biochip scanning device
61 light source
62 excitation spectral filter
63 optical grating hologram
64 focusing object lens
65 sampling stage
651 specimen
66 fluorescent emission spectral filter
67 sensor imaging lens
68 linear charge coupled device
69 light splitter
8 front-projecting reflective type biochip scanning device
81 linear light source
82 excitation spectral filter
83 light splitter
84 focusing object lens
85 sampling stage
851 specimen
86 fluorescent emission spectral filter
87 sensor imaging lens
88 signal detecting receiver
9 back-projecting transmissive type biochip scanning device

### DETAILED DESCRIPTION

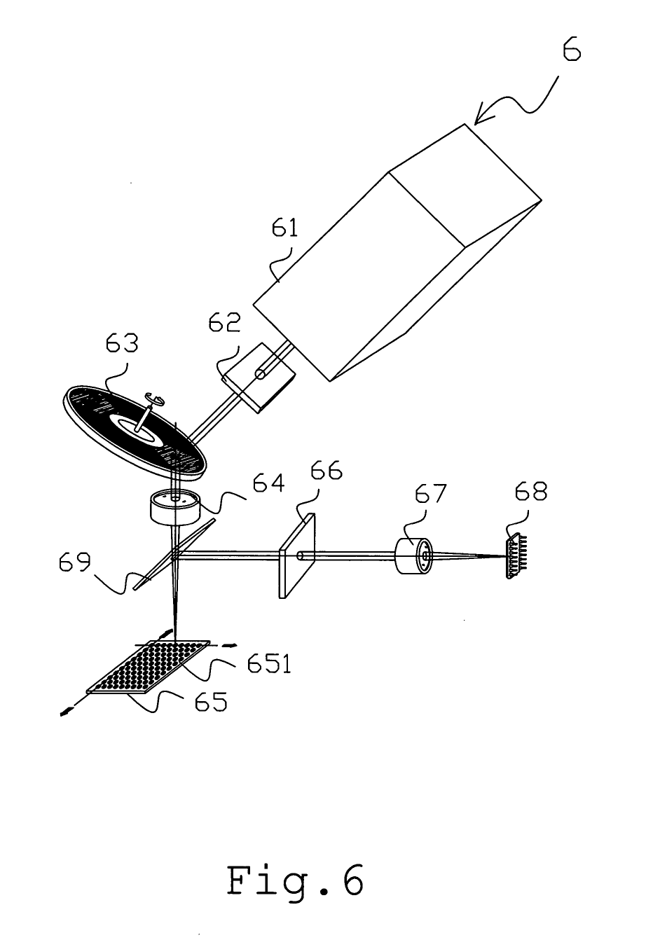

Please refer to FIG. 6, which is a schematic diagram of an embodiment of the present invention. As shown in FIG. 6, the front-projecting reflective type biochip scanning device 6 includes a light source 61 for emitting light, the light source can be a single point light source, and the type can be one of laser, incandescent light and gas exciting light; a rotatable optical grating hologram 63 located at one side of the light source 61 for diffracting the light to form a diffractive light; a sampling stage 65 located at one end of the optical grating hologram 63, the sampling stage 65 is placed a specimen 651 and can be freely moved along the X-Y directions to let the specimen single point scanned; and a linear charge coupled device (CCD) 68 that can receive a reflective light of the diffractive light via the specimen 651. In addition, an excitation spectral filter 62 cane further located between the light source 61 and the optical grating hologram 63 for excitation spectral filtering. A focusing object lens 64 and a light splitter 69 can be further located between the optical grating hologram 63 and the sampling stage 65. The focusing object lens 64 can focus light transmitting the optical grating hologram 63, and the light splitter 69 can transmit light in one side and can reflect the fluorescent signal from the specimen 651 in the other side. The fluorescent signal from the irradiated specimen 651 can be reflected by the light splitter 69 and pass through a fluorescent emission spectral filter 66 to filter. A sensor imaging lens 67 can focus the fluorescent signal passing through the fluorescent emission spectral filter 66, and then transmit to the linear charge coupled device (CCD) 68. When performing the scanning procedure, the rotatable optical grating hologram 63 will uniformly diffract the laser beam onto the specimen 651 and the focusing object lens 64 will rectify it, so that the laser beam can completely and uniformly irradiate onto the sampling stage 65 and can get more correct signal noise ratio to ensure accuracy of the light signal. The advantage of using the rotatable optical grating hologram 63 is that the problem of the rotation axis shift can be solved. The prerequisite is that the incident angle of the laser source should be controlled in the Bragg regime, about 1° to 30°, and the refractive angle will be equal to the incident angle. Under this situation, the angle shift is about one thousandth of using the multidimensional mirror or rotation mirror, so the little rotation axis shift can be omitted and the requirement of the optical grating hologram 63 can be raised.

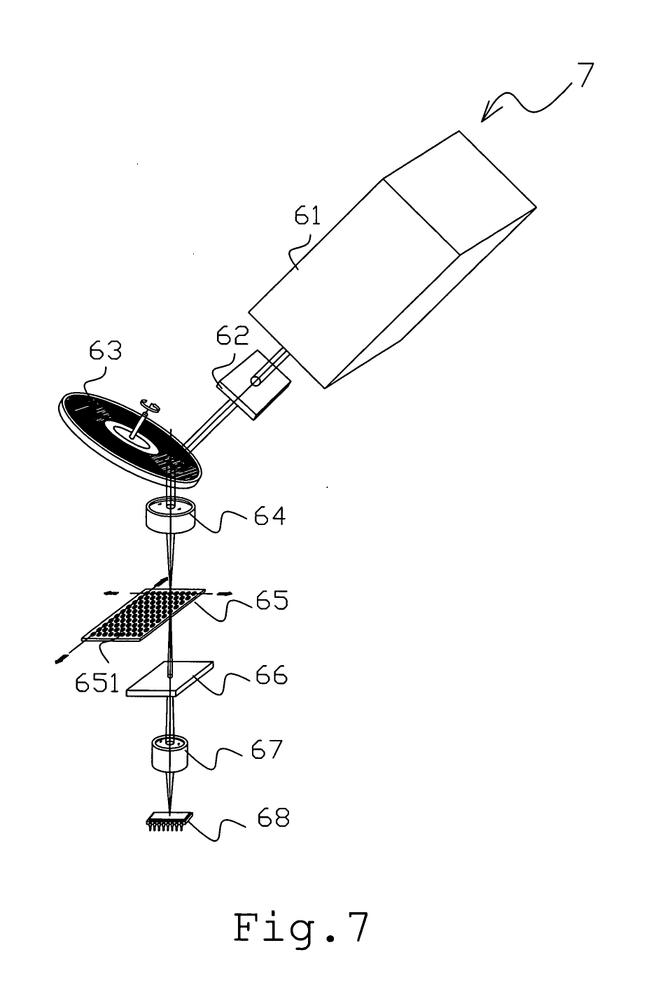

Please refer to FIG. 7, which is a schematic diagram of another embodiment of the present invention. As shown in FIG. 7, the structure of the back-projecting transmissive type biochip scanning device 7 is similar to that of the front-projecting reflective type biochip scanning device 6, but only the structure is the back-projecting transmissive type and the light splitter 69 is removed. The function and principle are all the same, and can get more correct signal noise ratio to ensure accuracy of the light signal.

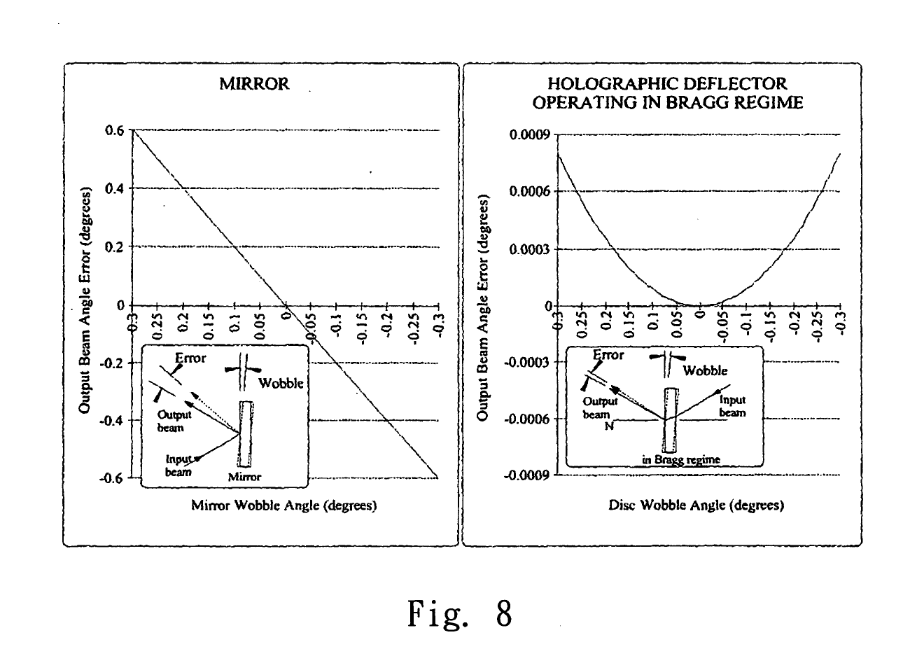

Please refer to FIG. 8, which is a comparison diagram of the shift of the mirror and the hologram. As shown in FIG. 8, the left diagram shows the relationship between the rotation axis swing angle of the general multidimensional mirror and the angle shift error after reflected, and the right diagram shows the shift relationship of the refraction angle while using the hologram. Scale in the left diagram is 1000 times of that in the right diagram. Hence, the shift with using the hologram is one thousandth of that with the multidimensional mirror.

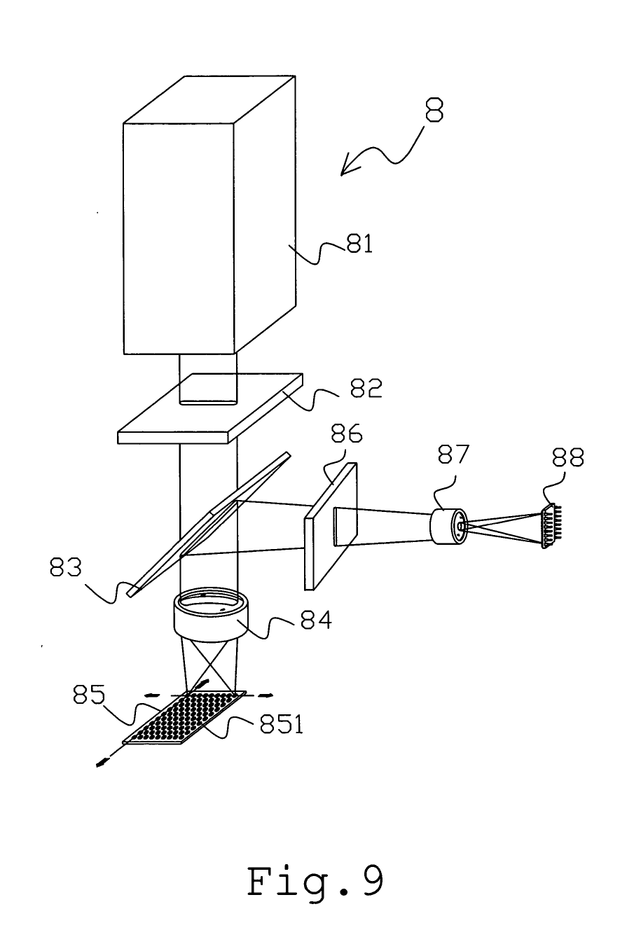

Please refer to FIG. 9, which is a schematic diagram of a further embodiment of the present invention. As shown in FIG. 9, the front-projecting reflective type biochip scanning device 8 includes a linear light source 81 for emitting light, the type of the linear light source 81 can be one of laser, incandescent light and gas exciting light; a light splitter 83 located at one side of the linear light source 81, the light splitter 83 can transmit light in one side and can reflect light in the other side; a sampling stage 85 located at one end of the light splitter 83, the sampling stage 85 is placed a specimen 851 and can be freely moved along the Y directions to let the specimen 851 scanned in a row; and a linear charge coupled device (CCD) 88 that can receive a reflective light of the linear light source 81 via the specimen 851. In addition, an excitation spectral filter 82 can be further located between the linear light source 81 and the light splitter 83 for filtering the wavelength accuracy of the excited light required by the fluorescent stain. A focusing object lens 84 can be further located between the light splitter 83 and the sampling stage 85. The focusing object lens 84 can focus light transmitting the light splitter 83 and let it irradiate onto the specimen 851. The fluorescent signal from the irradiated specimen 851 can pass through a fluorescent emission spectral filter 86 to filter. A sensor imaging lens 87 can focus the fluorescent signal passing through the fluorescent emission spectral filter 86, and then transmit to the linear charge coupled device (CCD) 88.

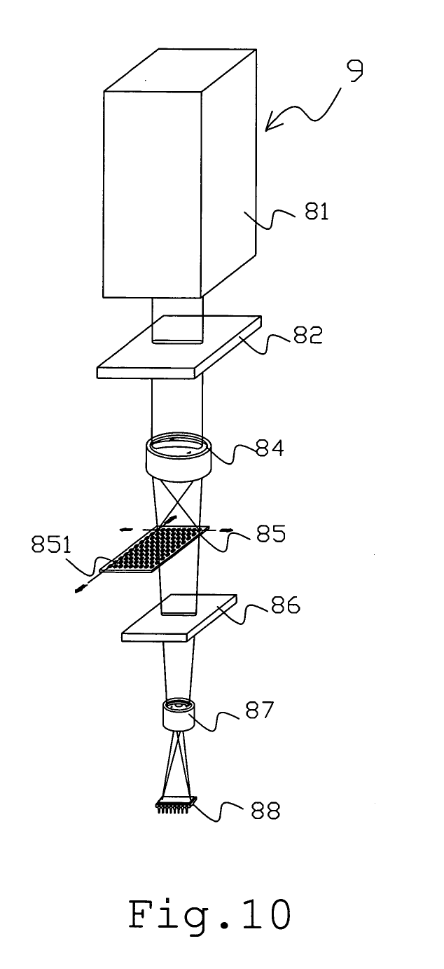

Please refer to FIG. 10, which is schematic diagram of a further embodiment of the present invention. As shown in FIG. 10, the structure of the back-projecting transmissive type biochip scanning device 9 is similar to that of the front-projecting reflective type biochip scanning device 8, but only the structure is the back-projecting transmissive type and the light splitter 69 is removed.

As shown in FIGS. 9 and 10, when performing the scanning procedure, the illumination method of the linear light source is utilized to irradiate the specimen and increase the scanning points. The linear charge coupled device is further utilized to receive the sampling signal to improve the scanning speed, improve the efficiency and save time.

In contrast to the prior art, the present invention of the biochip scanning device can solve the above-mentioned disadvantages of the prior art, so that can get more correct signal noise ratio to ensure accuracy of the light signal.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A biochip scanning device comprising:
a light source for emitting a light;
a rotatable optical grating hologram located at one side of the light source for diffracting the light to form a diffractive light;
a sampling stage that can be placed a specimen and can be irradiated with the diffractive light; and
a linear charge coupled device that can receive a reflective light of the diffractive light via the specimen.

2. The biochip scanning device of claim 1, wherein type of the light source can be one of laser, incandescent light and gas exciting light.

3. The biochip scanning device of claim 1, wherein an excitation spectral filter can be located between the light source and the optical grating hologram.

4. The biochip scanning device of claim 1, wherein the sampling stage can be freely moved along X-Y directions.

5. The biochip scanning device of claim 1, wherein a focusing object lens can be located between the optical grating hologram and the sampling stage.

6. The biochip scanning device of claim 1, wherein a light splitter can be located between the optical grating hologram and the sampling stage.

7. The biochip scanning device of claim 1, wherein the reflective light of the diffractive light via the specimen can be transmitted to the linear charge coupled device via a fluorescent emission spectral filter.

8. The biochip scanning device of claim 1, wherein the reflective light of the diffractive light via the specimen can be transmitted to the linear charge coupled device via a sensor imaging lens.

9. A biochip scanning device comprising:
a linear light source for emitting a linear light;
a sampling stage that can be placed a specimen and can be irradiated with the linear light; and
a linear charge coupled device that can receive a reflective light of the linear light via the specimen.

10. The biochip scanning device of claim 9, wherein type of the light source can be one of laser, incandescent light and gas exciting light.

11. The biochip scanning device of claim 9, wherein an excitation spectral filter can be located between the linear light source and the sampling stage.

12. The biochip scanning device of claim 9, wherein a light splitter can be located between the linear light source and the sampling stage.

13. The biochip scanning device of claim 9, wherein a focusing object lens can be located between the linear light source and the sampling stage.

14. The biochip scanning device of claim 9, wherein the sampling stage can be freely moved along X-Y directions.

15. The biochip scanning device of claim 9, wherein the reflective light of the linear light via the specimen can be transmitted to the linear charge coupled device via a fluorescent emission spectral filter.

16. The biochip scanning device of claim 9, wherein the reflective light of the linear light via the specimen can be transmitted to the linear charge coupled device via a sensor imaging lens.
